(19) United States
(12) Patent Application Publication
(10) Pub. No.: US 2014/0004229 A1
(43) Pub. Date: Jan. 2, 2014

(54) Pizza and Method of Preparation

(71) Applicant: Steven DeLisle, Plymouth, MA (US)

(72) Inventor: Steven DeLisle, Plymouth, MA (US)

(21) Appl. No.: 13/537,888

(22) Filed: Jun. 29, 2012

(51) Int. Cl. A21D 13/00; B65D 85/00; A21D 2/00; A23P 1/08

(52) U.S. Cl. 426/90; 426/420; 426/392; 426/302

(57) ABSTRACT

A food composition having a pizza separated into a small portion and a large portion. The large portion of the pizza having an aperture in which a container of a secondary food item is positioned. The large portion and container may be boxed in a specially designed box to accommodate both. The small portion may be provided with, or separately from the large portion.

### BACKGROUND OF THE INVENTION

1. Field of the Invention

The present invention relates generally to food and food preparation. More particularly the present invention relates to a pizza and side order combination.

2. Description of Related Art

People often face difficulty when they try to carry the multiple pizza boxes from a takeout order. As the person walks with the pizzas, the boxes slide against each other. Balancing appetizer boxes on top of the pizza boxes pose an even greater challenge to the person carrying the order. If the person is not careful, the smaller boxes can fall.

Also, traditional takeout boxes create a large amount of waste when a person orders multiple pizzas and appetizers. The clunky pizza and appetizer boxes take up space when they are disposed in a trashcan or recycle bin after a meal.

Takeout pizza provides an additional problem to those people who are watching their weight. It is often difficult to monitor calories when pizza slices are uneven. People are likely to overeat, as it is tempting to grab another slice because the pizza is not individually portioned. Further, people enjoy ordering an appetizer, such as wings or garlic bread, to accompany their pizza. If a person orders an appetizer with his pizza, he is likely to consume more calories than if he just ordered the pizza alone.

Although many children love pizza, many children hate eating the pizza's crust. The crust ends up going to waste.

Lastly, pizza served in traditional boxes can be hard to divide during social events. Everyone who wants a slice must crowd around the box, often causing a wait.

Therefore, what is needed is a novel pizza and side order presentation to enhance the pizza eating experience, and add convenience to presentation and transportation.

### SUMMARY OF THE INVENTION

The subject matter of this application may involve, in some cases, interrelated products, alternative solutions to a particular problem, and/or a plurality of different uses of a single system or article.

In one aspect, a food composition is provided. The composition may comprise a pizza, the pizza having at least a dough layer, and another layer such as sauce, cheese, and the like. This pizza is separated into a large portion and a small portion by removing the small portion from the large portion, forming an aperture in the large portion. A container is positioned in the aperture of the large portion. In the container is a secondary food item such as wings, breadsticks, dipping sauce and the like.

In another aspect, a method of forming a food product is provided. The method begins with forming a pizza and cutting the pizza to form a large portion and a small portion. The small portion is removed, leaving an aperture formed by the large portion. A container is placed within the aperture, and a secondary food item such as wings, breadsticks, dipping sauce and the like, is placed within the container.

### BRIEF DESCRIPTION OF THE DRAWINGS

FIG. 1 provides a perspective view of an embodiment of the pizza.

FIG. 2 provides an embodiment of the pizza that is cut to form the large portion and the small portion

FIG. 3 provides a detail view of an embodiment of the container.

FIG. 4 provides a side cutaway view of an embodiment of the box and pizza stored therein.

FIG. 5 provides a flow chart of an embodiment of a method of preparation of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a pizza having a portion removed, thereby forming an aperture through the pizza, and a container of a secondary food item positioned in the aperture. The removed portion may comprise a small pizza, which may be provided and marketed as such. A box may contain the pizza and container and act as a convenient transportation structure.

The term pizza is used herein to refer broadly to any flat dough-based food item with a topping or toppings and may be sweet or savory. Toppings may include cheese, sauce, along with any other toppings that may be desired. In one embodiment, pizza may have sauce only and no cheese. In another embodiment, pizza may have cheese and no sauce. In still another embodiment pizza may have cheese and sauce. In yet another embodiment, pizza may have cheese, sauce and additional toppings. Further, the term pizza used herein may refer to either cooked, uncooked and/or frozen items having a dough layer and topping layer.

Once formed as a pizza, a portion may be removed, forming a large portion and a small portion of the pizza. In most embodiments, the small portion and large portion are to be formed from the same original pizza. In one embodiment, the small portion may be removed prior to cooking. In another embodiment, the small portion may be removed after cooking. Further, the pizza may be frozen and cut, or cut, and then frozen.

The pizza may be cut into a large portion and small portion in any manner capable of separating the small portion from the large portion. In one embodiment, the pizza may be cut using a cutting device. In another embodiment, a ring shaped implement having a perimeter equal to the perimeter of the small portion may be used. The implement may have a sharpened leading edge that may be pressed into the pizza, thereby cutting the perimeter of the small portion and separating it from the large portion. In another embodiment, a cutting saw may be used to cut the small portion. In still another embodiment a rolling knife may be used to cut the small portion. In yet another embodiment, a knife may be used to cut the small portion.

The pizza, the large portion and the small portion may have varying shapes depending on intention of the chef. In one embodiment, the small portion may have an identical shape to the large portion, except smaller. For example a circular pizza may create a circular ring large portion and a circular small portion. In another embodiment, a rectangular pizza may create a rectangular ring large portion and a rectangular small portion.

The small portion may be removed from any part of the pizza. In one embodiment, the small portion may be removed from a center of the pizza. In another embodiment, the small portion may be removed from a side, edge, or off center position of the pizza.

In an embodiment having a circular pizza, the small portion may be removed from the center of the pizza forming concentric circles as the inner and outer perimeter of the large portion.

A container may be positioned within the aperture of the large portion of the pizza. The container may contain a secondary food item. The secondary food item may be any edible product, though preferably one complimentary to a pizza. Food items contemplated herein may include, but are not limited to: dipping sauces, wings, bread sticks, hot peppers, jalapeno poppers, French fries, onion rings, tortilla chips, and the like. The container may be of any size and shape. Preferably the container may have a cross section that matches or is slightly smaller than the cross section of the aperture of the large portion. In one embodiment, the container may have a circular cross section with an approximately four inch diameter.

The container may be constructed of any material capable of containing food and being exposed to a pizza. Materials of which the container may be made include but are not limited to: paper, plastic, metal, wood, ceramic, other food material such as a nacho or bread bowl, and the like.

The container may further comprise a cover to contain the secondary food item within the container. The cover may be removably attachable to the container. Examples of removable attachments of the cover to container may include threaded connections, snap fit connections, pressure fit connections, latched connections, hinged connections, and the like. In one embodiment, the cover may be transparent or translucent to allow a viewer to see within the container while the cover is attached.

In another embodiment, the container may have a flange extending from its bottom surface. This flange may extend underneath the pizza when the container is positioned in the aperture of the large portion, and may secure the container and pizza in place.

The large portion and container, and optionally the small portion may all be packaged in a box. The box may be of any size and shape that may contain the large portion of the pizza and at least part of the container. In one embodiment, the container may protrude from the box. In another embodiment, the container may be contained within the box. In still another embodiment, the container may be contained within the box while a cover for the container protrudes from the box. In embodiments where the cover or container protrude from the box, the cover may be removable from the container without opening the top of the box, allowing access to the secondary food item within the container. Alternatively, the cover may be formed into the box.

The box may be of varying size depending on the size of the large portion of pizza intended to be contained within the box and/or the container. In one embodiment, the box may be approximately twenty inches square and approximately six inches in height.

In one embodiment, a top of the box may be connected to the remainder of the box such that it may swing open about a hinge of the box. In another embodiment, the top of the box may be fully removable from the remainder of the box. In still another embodiment the top may be slideably attached to a base of the box.

In embodiments having a portion of the container or container cover protruding, a top cover of the box may have an aperture sized to accommodate the container or cover. In still a further embodiment, the cover may attach to the top of the box which, when closed, may provide a seal around the container.

In one embodiment, a bottom interior of the box may have a protrusion that matches the aperture of the large portion of the pizza. This protrusion may allow the large portion to be properly seated in place and held in place. Further, the protrusion may align and support the container. In one embodiment the protrusion may be a separate item from the box. In another embodiment, the protrusion may be stamped or pressed into the box, causing a protrusion on the bottom interior surface and a depression in the bottom exterior surface of the box. In still another embodiment, the protrusion may extend from the bottom surface but may be integral with the box material.

In one embodiment of the box having a protrusion pressed into the bottom, and a cover of the container protruding from the top, a plurality of boxes may be stackable. In this embodiment, the protrusion formed by the cover from the top may seat at least partially into the depression formed into the bottom of a second box.

The box may be formed from any material capable of containing and storing pizza temporarily, as well as supporting the container. Materials of which the box may be made include but are not limited to paper, plastic, a composite, and the like. Further, the box may be disposable, or may be reusable. The box may be used for delivery or take out applications, and may also be utilized as a serving device for in restaurant service.

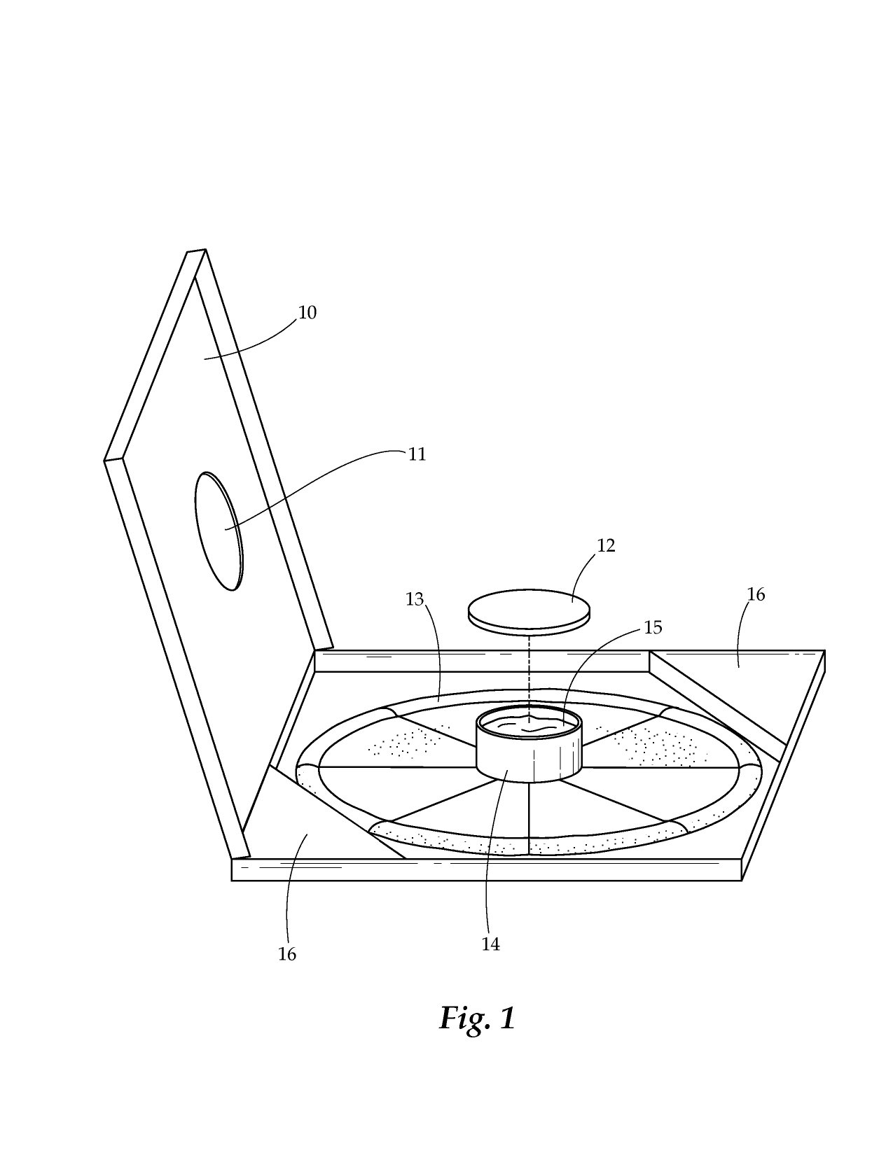

Turning now to FIG. 1 a perspective view of an embodiment of the pizza is provided. A large portion of the pizza 13 is positioned within a box 10. A small portion of the pizza (not shown) has been removed from the pizza, thereby forming an aperture within the large portion 13. The box 10 having a top and bottom, the top being shown in an open position and hingedly attached to the bottom. The top of the box 10 has an aperture 11 at its center. The aperture may allow passage of a cover 12 of a container 14. The container 14 is positioned within an aperture formed at the center of the large portion 13. Within the container 14 is a secondary food item 15. Optional spacers 16 aid in positioning the pizza in a proper place to receive and stabilize the container 14.

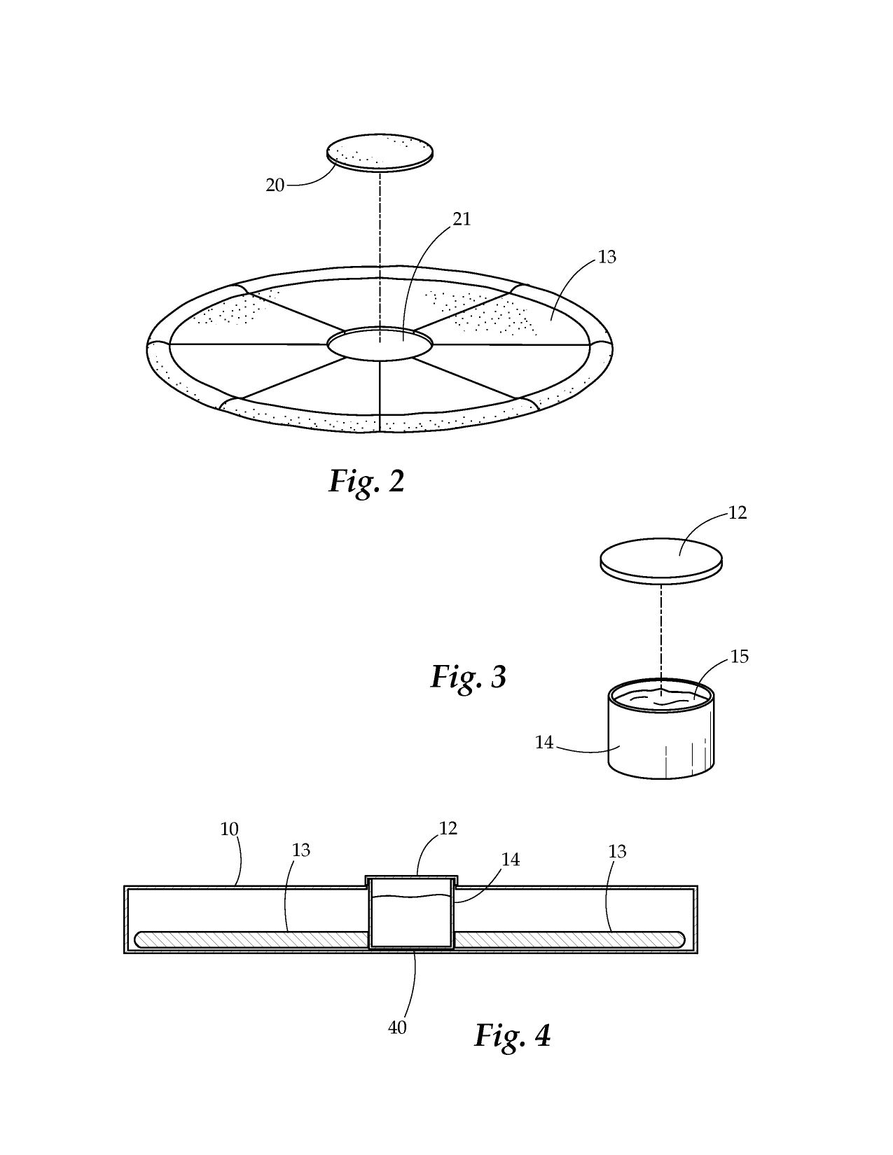

FIG. 2 shows an embodiment of the pizza that is cut to form the large portion and the small portion. Initially the pizza is formed as a single pizza. Once formed a large portion 13 is formed by cutting a small portion 20 from the pizza, forming an aperture 21 in the large portion 13.

FIG. 3 provides a detail view of an embodiment of the container. The container 14 is shown here as a cylindrical container having an outer diameter approximately equal to an aperture of a large portion of the pizza (not shown). A removable lid 12 is attachable to the container 14 to secure contents within the container. A secondary food item 15 is positioned within the container 14 for access by a consumer.

FIG. 4 provides a side cutaway view of an embodiment of the box and pizza stored therein. The box 10 is shown in a closed position, containing the large portion of the pizza 13 and container 14 therein. The box 10 has a substantially rectangular cross section. The container 14 is secured within the box 10, while the cover 12 protrudes through an aperture of the box (not shown) above a top surface of the box 10. The container 14 is held in place by the large portion of pizza 13 and the top of the box 10 through which the cover 12 protrudes. A protrusion 40 is formed on the bottom of the box 10. This protrusion 40 urges the large portion of the pizza 13 into its proper centered position within the box, aligning the aperture of the pizza (not shown) with the aperture of the top of the box 10.

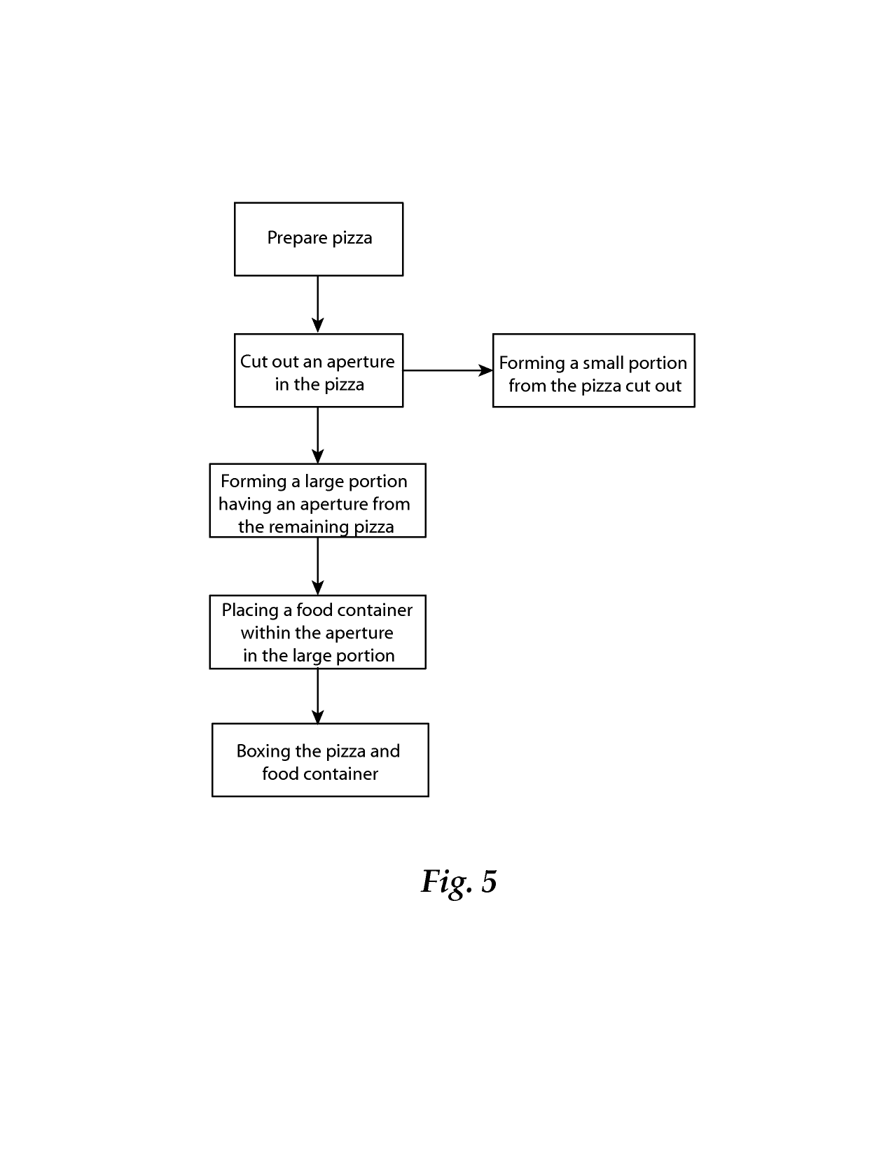

FIG. 5 provides a flow chart of an embodiment of a method of preparation of the present invention. In this embodiment, initially a full pizza is prepared. Next, an aperture is cut into the pizza forming a small portion which may be set aside, and a large portion. The small portion may be used for various food based uses such as a kids meal, or small pizza portion, among others. Next a container is positioned within the aperture of the large portion formed by the removal of the small portion. The container either having food therein, or being capable of storing food items. Finally the pizza and container combination may be boxed to create a finished product for presentation to a customer.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A food composition comprising:
a pizza, the pizza comprising a dough layer, the pizza being cut into a large portion of pizza and a small portion, the small portion leaving an aperture in the large portion of pizza when separated;
a container positioned within the aperture of the large portion of pizza; and
a secondary food item positioned within the container.

2. The food composition of claim 1 further comprising a cover, the cover constructed and arranged to seal an opening of the container.

3. The food composition of claim 1 wherein the pizza is cooked before separation into the large portion of pizza and the small portion.

4. The food composition of claim 1 wherein the large portion of pizza has a substantially circular perimeter, and wherein the small portion has a substantially circular perimeter, the small portion being removed from a center of the pizza, forming an aperture that is concentric with the perimeter of the large portion of the pizza.

5. The food composition of claim 1 further comprising a box, the large portion of pizza and the container being positioned within the box.

6. The food composition of claim 5 wherein a top of the box forms an aperture sized to allow passage of the container.

7. The food composition of claim 5 wherein the box further comprises a top, the top being hingedly attached to the box, the top having a first open position and a second closed position.

8. The food composition of claim 5 wherein a bottom of the box comprises a protrusion aligned with the aperture of the large portion of pizza when the large portion of pizza is positioned within the box.

9. The food composition of claim 8 wherein the protrusion is formed by pressing the bottom of the box, urging the protrusion upward.

10. A method of forming a food product comprising the steps of:
forming a pizza;
cutting the pizza, forming a large portion of pizza and a small portion;
forming an aperture in the large portion of pizza by removing the small portion from the large portion of pizza, thereby;
placing a container within the aperture of the large portion of pizza;
placing a secondary food item within the container.

11. The method of forming a food product of claim 10 further comprising the step of placing a cover on the container.

12. The method of forming a food product of claim 10 further comprising the steps of:
placing the large portion of pizza in a box; and
placing the container in the box.

13. The method of forming a food product of claim 12 further comprising the step of allowing the container to be aligned with an aperture in a top of the box.

14. The method of forming a food product of claim 13 further comprising the step of allowing a cover attached to the container to protrude from the aperture in the top of the box.

15. The method of forming a food product of claim 12 further comprising the step of placing the small portion in the box.

16. The method of forming a food product of claim 12 further comprising the step of aligning the aperture of the large portion of pizza with a guide at a bottom of the box.

17. The method of forming a food product of claim 10 wherein the step of preparing the pizza comprises the steps of:
arranging a quantity of dough;
placing a layer of sauce over the quantity of dough;
placing a layer of cheese over the layer of sauce; and
baking the dough, sauce and cheese.

18. The method of forming a food product of claim 10 further comprising the step of providing the small portion as a kid's meal.

19. The method of forming a food product of claim 10 further comprising the step of freezing the large portion of pizza.

20. The method of forming a food product of claim 10 further comprising the step of cooking the pizza after the step of cutting the pizza.
